(19) United States
(12) Patent Application Publication
(10) Pub. No.: US 2023/0398622 A1
(43) Pub. Date: Dec. 14, 2023

(54) SYSTEMS AND METHODS FOR WELD PROCESS SELECTION AND ISOLATION FROM A VOLTAGE SENSING WIRE FEEDER

(71) Applicant: Illinois Tool Works Inc., Glenview, IL (US)

(72) Inventors: Daniel Jacob Mortensen, Black Creek, WI (US); Darin Dickinson, Winneconne, WI (US); Brian Lee Ott, Sherwood, WI (US); Quinn William Schartner, Kaukauna, WI (US)

(21) Appl. No.: 18/331,302

(22) Filed: Jun. 8, 2023

Related U.S. Application Data
(60) Provisional application No. 63/350,773, filed on Jun. 9, 2022.

(51) Int. Cl. B23K 9/10; B23K 9/095; B23K 9/12

(52) U.S. Cl. CPC B23K 9/1062; B23K 9/0953; B23K 9/124

(57) ABSTRACT

Systems and methods are disclosed for automatically isolating a gouging power output from a welding power output responsive to a weld process selection. In particular, the disclosed systems and methods provide isolation circuitry to isolate the welding power output from the gouging power output, such that power conversion circuitry provides the gouging power to the gouging power output and prevents any power to the welding power output

### CROSS REFERENCE TO RELATED APPLICATIONS

This application is a Non-Provisional Patent Application of U.S. Provisional Patent Application No. 63/350,773 entitled “Systems And Methods For Weld Process Selection And Isolation From A Voltage Sensing Wire Feeder” filed Jun. 9, 2022, which is herein incorporated by reference in its entirety.

### BACKGROUND

Welding is a process that has increasingly become ubiquitous in nearly all industries. Conventional systems and methods for short circuit welding processes, such as welding, brazing, adhesive bonding, and/or other joining operations, require substantial investments in equipment, such as processing, displays, practice workpieces, welding tool(s), sensor(s), and/or other equipment.

Conventional welding systems may be capable of operating in a single mode, such as an arc welding mode or a gouging mode. Thus, operators who wish to perform both wire welding and gouging at a given jobsite require two separate power sources, and may have to leave the work area to change settings of the welding power supply and/or the welding wire feeder in order to switch between modes.

Thus, systems and methods that provide effective and simple control of multi-mode welding systems is desirable.

### SUMMARY

The present disclosure is directed to systems and methods that includes isolation circuitry between a welding power output and a gouging power output to automatically isolate one power output from the other power output responsive to a weld process selection, substantially as illustrated by and/or described in connection with at least one of the figures, and as set forth in the claims.

These and other advantages, aspects and novel features of the present disclosure, as well as details of an illustrated example thereof, will be more fully understood from the following description and drawings.

### DRAWINGS

FIG. 1 illustrates a welding-type system to automatically isolate gouging and welding outputs, in accordance with aspects of this disclosure.

FIG. 2 provides a flowchart representative of example machine-readable instructions which may be executed by the example welding-type system of FIG. 1 to automatically isolate gouging and welding outputs, in accordance with aspects of this disclosure.

FIG. 3 illustrates an example pilot circuit for the example welding-type system of FIG. 1, in accordance with aspects of this disclosure.

The figures are not necessarily to scale. Where appropriate, similar or identical reference numbers are used to refer to similar or identical components.

### DETAILED DESCRIPTION

The present disclosure is directed to systems and methods for automatically isolate gouging and welding outputs. For example, for welding power supplies and/or welding wire feeders that are configured to operate both wire welding processes (e.g., gas metal arc welding (GMAW), flux-cored arc welding (FCAW), shielded metal arc welding (SMAW)) as well as gouging operations (e.g., Carbon Arc Cutting-Air (CAC-A)), isolation circuitry is arranged between a welding power output and a gouging power output to automatically isolate one power output from the other power output responsive to a weld process selection.

In response to a weld process selection input to provide gouging power, control circuitry of the welding wire feeder transmits a control signal to a welding power supply to provide the gouging power. The isolation circuitry isolates the welding power output from the gouging power output, such that power conversion circuitry provides the gouging power to the gouging power output and prevents any power to the welding power output.

Conventionally, operators who wish to perform both wire welding and gouging at a given work area have limited options. For example, separate power sources may be needed for each process to ensure full functionality. The operator may be required to walk to the welding power supply and/or the welding wire feeder in order to change settings or select a welding process. In some examples, the operator may use a Y-cord on the welding circuit to connect both the wire feeder and gouge torch. However, given that each process requires specific outputs, one or both of the processes experience degraded performance when operating on the settings of the other. For example, employing a constant voltage (CV) process (common in arc welding operations) for gouging translates into lower performance in comparison to a dedicated constant current (CC) process.

In disclosed examples, a single power source and wire feeder are provided to support both arc welding and gouging operations. To ensure selection, transition, and/or execution of each operation is seamlessly and effectively executed, isolation circuitry is provided in the wire feeder. The isolation circuitry electrically or physically isolates the welding power output from the gouging power output, connected to a welding torch and a gouging torch, respectively. In some examples, the isolation circuitry isolates power conversion circuitry from welding power circuitry (feeding the welding output), and/or from gouging power circuitry (feeding the gouging output). Thus, in some examples, more than a single point of isolation may exist between the power conversion circuitry and the welding or gouging torch.

Although welding process and polarity changes are implemented at the power supply, the isolation circuitry for the multiple weld outputs in the wire feeder (or other remote device, pendent, etc.) ensures circuit isolation and gouge function is available regardless of capabilities of the power source.

This idea is unique in that the wire feeder commands a welding process without a communication cable. When connected to a fully featured power source the appropriate process will be activated and the appropriate polarity will be applied to the wire feeder. In addition to this the wire feeder will apply power to the appropriate output/torch and deactivate the others. The isolation function that occurs in the feeder will work regardless of the capabilities of the power source in the system.

Advantageously, the discloses systems and methods allows the operator to remain in position at a work area to perform both welding and gouging operations without the need to disconnect cables or torches, and/or walk to the welding power supply to transition between operations. Further, the operator gets the correct weld settings and performance to ensure a quality weld. Moreover, electrical and/or physical isolation between the torches prevents damage to the torches and/or the workpiece.

In disclosed examples, a wire feeder includes isolation circuitry between a welding power output and a gouging power output to automatically isolate one power output from the other power output responsive to a weld process selection; and control circuitry configured to receive a weld process selection input to provide gouging power; transmit a control signal to a welding power supply to provide the gouging power; control the isolation circuitry to isolate the welding power output from the gouging power output; and control power conversion circuitry to provide the gouging power to the gouging power output.

In some examples, the welding power output includes welding power circuitry and the gouging power output includes gouging power circuitry.

In some examples, the welding power circuitry provides welding power to a welding torch via the welding power output and the gouging power circuitry provides the gouging power to a gouging torch via the gouging power output.

In some examples, the isolation circuitry is further configured to: electrically or physically isolate the welding power output from the welding power circuitry; or electrically or physically isolate the gouging power output from the gouging power circuitry.

In some examples, the power conversion circuitry is operable to receive power from the welding power supply and to provide welding power or the gouging power to the wire feeder via one or more cables.

In some examples, the control circuitry is further configured to communicate the command to control circuitry of the welding power supply via one or more of weld cable communications (WCC), wireless communications, wired communications, or any combination thereof.

In some examples, the control circuitry of the welding power supply is configured to automatically adjust output polarity of the gouging power to a polarity suitable for a gouging operation in response to a command from the wire feeder control circuitry to provide gouging power.

In disclosed examples, a system includes a welding power supply to supply a power output; one or more welding torches; and a wire feeder coupled between the welding power supply and the one or more welding torches, the wire feeder comprising: isolation circuitry to physically or electrically isolate a welding power output from a gouging power output; and control circuitry configured to: receive an input to provide gouging power; control the isolation circuitry to isolate the welding power output from the gouging power output; and control power conversion circuitry to provide the gouging power to the gouging power output.

In some examples, the wire feeder is located remotely from the welding power supply and proximate to the one or more welding torches.

In some examples, the one or more welding torches includes a welding torch to perform a welding operation and a gouging torch to perform a gouging operation.

In some examples, the power conversion circuitry is operable to receive power from the welding power supply and to condition the power to provide welding power or the gouging power.

In some examples, the control circuitry is further configured to transmit a control signal to the welding power supply to provide power with a polarity suitable for the gouging power.

In some examples, the isolation circuitry includes a physical interlock comprising one or more of a relay, a contactor, or a switch.

In some examples, the isolation circuitry is electrically controlled by the control circuitry to close a circuit to the welding power output or the gouging power output.

In some examples, a user interface receives a command to provide the input to provide the welding power or the gouging power.

In some examples, the welding power supply includes welding control circuitry configured to automatically adjust output polarity of the gouging power to a polarity suitable for a gouging operation in response to a command from the wire feeder control circuitry to provide gouging power.

In some examples, the welding power supply communicates with the wire feeder via a weld power cable.

In disclosed examples, welding system includes a welding power supply to supply a power output, the welding power supply comprising first power conversion circuitry; and a wire feeder comprising: isolation circuitry to physically or electrically isolate a welding power output from a gouging power output; and control circuitry configured to: receive an input to provide gouging power; transmit a control signal to the welding power supply to control the power conversion circuitry to adjust a polarity of the power output for gouging power; control the isolation circuitry to isolate the welding power output from the gouging power output; and control second power conversion circuitry to provide the gouging power via the gouging power output.

In some examples, the control circuitry is further configured to control the second power conversion circuitry to provide the gouging power as a constant current power output.

In some examples, the isolation circuitry is configured to electrically or physically isolate the welding power output from the gouging power output.

The term “welding-type system,” as used herein, includes any device capable of supplying power suitable for welding, plasma cutting, induction heating, Carbon Arc Cutting-Air (e.g., CAC-A, or gouging), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding).

As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith. The term can include engine driven power supplies, energy storage devices, and/or circuitry and/or connections to draw power from a variety of external power sources.

As used herein, the term “wire feeder” includes the motor or mechanism that drives the wire, the mounting for the wire, and controls related thereto, and associated hardware and software.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to implement a welding process.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit,” “control circuitry,” and/or “controller,” as used herein, may include digital and/or analog circuitry, discrete and/or integrated circuitry, microprocessors, digital signal processors (DSPs), Field Programmable Gate Arrays (FPGAs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “memory” includes volatile and non-volatile memory devices and/or other storage device.

As used herein, the term “energy storage device” is any device that stores energy, such as, for example, a battery, a supercapacitor, etc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, plasma cutting, cutting process, and/or any other type of welding process.

As used herein, the term “welding program” or “weld program” includes at least a set of welding parameters for controlling a weld. A welding program may further include other software, algorithms, processes, or other logic to control one or more welding-type devices to perform a weld.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, the term “boost converter” is a converter used in a circuit that boosts a voltage. For example, a boost converter can be a type of step-up converter, such as a DC-to-DC power converter that steps up voltage while stepping down current from its input (e.g., from the energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

As used herein, the terms “first” and “second” may be used to enumerate different components or elements of the same type, and do not necessarily imply any particular order.

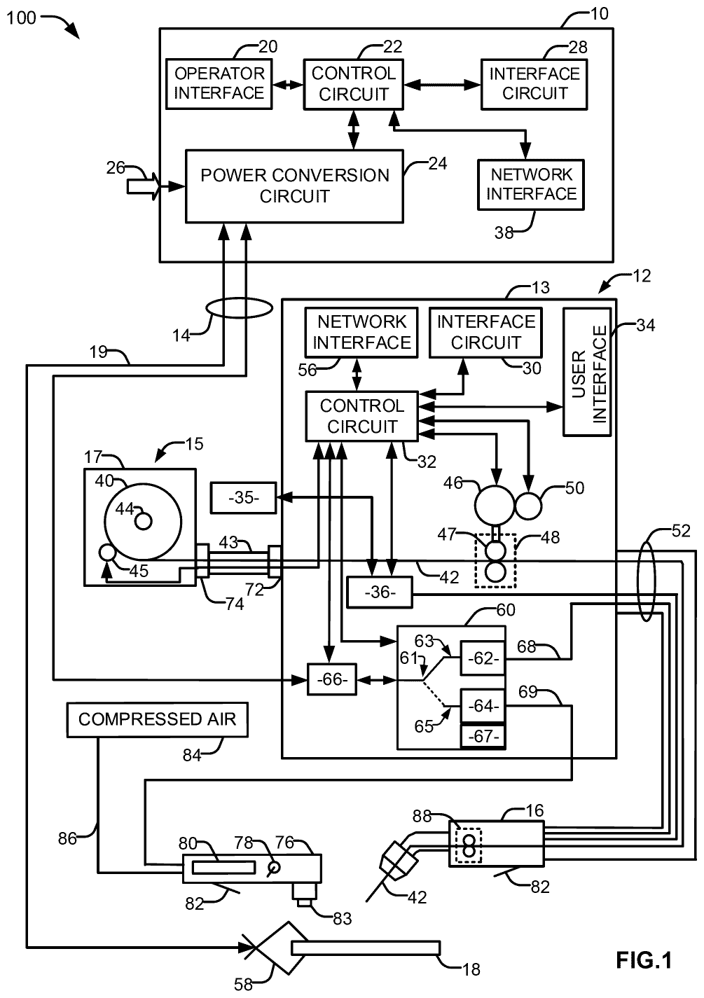

FIG. 1 illustrates an example welding system 100 for performing welding operations. As shown in the welding system 100 of FIG. 1, a power supply 10 and a wire feeder 12 are coupled via conductors or conduits 14. In the illustrated example, the power supply 10 is separate from the wire feeder 12, such that the wire feeder 12 may be positioned near a welding location at some distance from the power supply 10. Terminals are typically provided on the power supply 10 and on the wire feeder 12 to allow the conductors 14 or conduits to be coupled to the systems so as to allow for power and gas to be provided to the wire feeder 12 from the power supply 10, and to allow data to be exchanged between the two devices.

The system 100 is configured to provide wire from a welding wire source 15, power from the power supply 12, and shielding gas from a shielding gas supply 35, to a welding tool or torch 16. The torch 16 may be any type of arc welding torch, (e.g., GMAW, GTAW, FCAW, SMAW) and may allow for the feed of a welding wire 42 (e.g., an electrode wire) and gas to a location adjacent to a workpiece 18, responsive to a trigger 82. A work cable 19 is run to the welding workpiece 18 so as to complete an electrical circuit between the power supply 10 and the workpiece 18.

The welding system 100 is configured for weld settings (e.g., weld parameters, such as voltage, wire feed speed, current, gas flow, inductance, physical weld parameters, advanced welding programs, pulse parameters, etc.) to be selected by the operator and/or a welding sequence, such as via an operator interface 20 provided on the power supply 10. The operator interface 20 will typically be incorporated into a front faceplate of the power supply 10, and may allow for selection of settings such as the weld process, the type of wire to be used, voltage and current settings, and so forth. In particular, the example system 100 is configured to allow for welding with various steels, aluminums, or other welding wire that is channeled through the torch 16. Further, the system 100 is configured to employ welding wires with a variety of wire sizes. These weld settings are communicated to a control circuit 22 within the power supply 10. The system may be particularly adapted to implement welding regimes configured for certain electrode types. The control circuit 22 operates to control generation of welding power output that is supplied to the welding wire 42 for carrying out the desired welding operation.

The torch 16 applies power from the power supply 10 to the wire electrode 42, typically by a welding cable 52. Similarly, shielding gas from a shielding gas supply 35 is fed through the wire feeder 12 and the welding cable 52. During welding operations, the welding wire 42 is advanced through a jacket of the welding cable 52 towards the torch 16.

The work cable 19 and clamp 58 allow for closing an electrical circuit from the power supply 10 through the welding torch 16, the electrode (wire) 42, and the workpiece 18 for maintaining the welding arc during the operation. In addition to torch 16 in some examples multiple torches of a variety of types may be connected to the wire feeder 12. In examples, a gouging or cutting torch 76 may be separately connected to the wire feeder 12 and/or the power supply 10.

In some examples, the wire feeder 12 is a voltage sensing wire feeder. A work sensing line can be coupled to the power supply 10 and the work piece 18 to enable the power supply 10 to detect the polarity even when no welding operation is active. More specifically, the work sensing line completes an electrical circuit between the power supply 10, the wire feeder 12, the work piece 18, and back to the power supply 10 to enable the polarity to be detected. For example, detection of the polarity may include sensing a voltage of each output 62, 64, a current flowing through the cables 68, 69, or both.

As shown, the gouging torch 76 includes a trigger 82 to control an output of the torch 76 and a selector 78 (e.g., a mechanical and/or electronic switch) to control flow of air, such as from a compressed air source 84. Although illustrated as located on torch 76, the selector 78 (and/or valve 80) may be located on the wire feeder 12, the power supply 10, and/or along a length of tubing 86 that provides air flow to the torch 76. In some examples, the compressed air source 84 (e.g., an air compressor) may be connected to one or more of the control circuitry 22, 32, and may draw power from the power conversion circuit 24, 66 and/or an alternative power source (e.g., an energy storage device, mains power, etc.).

The control circuit 22 is coupled to power conversion circuit 24. This power conversion circuit 24 is adapted to create the output power, such as pulsed waveforms applied to the welding wire 42 at the torch 16. Various power conversion circuits may be employed, including choppers, boost circuitry, buck circuitry, inverters, converters, and/or other switched mode power supply circuitry, and/or any other type of power conversion circuitry. The power conversion circuit 24 is coupled to a source of electrical power as indicated by arrow 26. The power applied to the power conversion circuit 24 may originate in the power grid, although other sources of power may also be used, such as power generated by an engine-driven generator, batteries, fuel cells or other alternative sources. The power supply 10 illustrated in FIG. 1 may also include an interface circuit 28 configured to allow the control circuit 22 to exchange signals with the wire feeder 12 and/or other auxiliary devices.

The wire feeder 12 includes a complimentary interface circuit 30 that is coupled to the interface circuit 28. In some examples, multi-pin interfaces may be provided on both components and a multi-conductor cable run between the interface circuit to allow for such information as wire feed speeds, processes, selected currents, voltages or power levels, and so forth to be set on either the power supply 10, the wire feeder 12, or both. Additionally or alternatively, the interface circuit 30 and the interface circuit 28 may communicate wirelessly and/or via the weld cable. In some examples, power supply 10 may communicate with the wire feeder 12 (and or another remote device) using weld cable communications (WCC) through the welding torch cable 14.

The wire feeder 12 also includes control circuit 32 coupled to the interface circuit 30. As described below, the control circuit 32 allows for wire feed speeds to be controlled in accordance with operator selections or stored sequence instructions, and permits these settings to be fed back to the power supply 10 via the interface circuit. The control circuit 32 is coupled to an operator interface 34 on the wire feeder that allows selection of one or more welding parameters, such as wire feed speed. The operator interface may also allow for selection of such weld parameters as the welding process type (including arc welding operation and/or gouging operation), the type of wire utilized, current, voltage or power settings, and so forth.

In some examples, the wire feeder 12 includes one or more power conversion circuits 66, which may be similar to power conversion circuit 24. For instance, the power conversion circuit(s) 66 in the wire feeder 12 may include choppers, boost circuitry, buck circuitry, inverters, converters, and/or other switched mode power supply circuitry, and/or any other type of power conversion circuitry to control power output to the welding torch 16, gouge torch 76, other types of welding tool, and/or one or more auxiliary outputs.

The control circuit 32 may also be coupled to gas control valving 36 which regulates and/or measures the flow of shielding gas from the shielding gas supply 35 to the torch 16. In general, such gas is provided at the time of welding, and may be turned on immediately preceding the weld and for a short time following the weld. The shielding gas supply 35 may be provided in the form of pressurized bottles.

The wire feeder 12 includes components for feeding wire to the welding torch 16 and thereby to the welding operation, under the control of control circuit 32. As illustrated, the drive components and control components of the wire feeder 12 are included within a first housing or enclosure 13. In some examples, a spool of wire 40 is mounted on a spool hub 44 in a second housing or enclosure 17. The wire source 15 may be integrated with the wire feeder 12. In some examples, the wire source 15 is physically independent from the wire feeder 12. In other words, the wire source 15 is connectable to and disconnectable from the wire feeder 12, and the wire source 15 can be physically moved independently from the wire feeder 12.

In some examples, the spool hub 40 is configured to support up to a sixty pound spool of wire and the enclosure 17 is large enough to enclose a sixty pound spool of wire. An inlet 72 of the wire feeder 12 is connected to an outlet 74 of the wire source 15 via one or more connectors 43. In some examples, the wire feeder inlet 72 is directly connected to the wire source outlet 74. For example, the wire feeder inlet 72 may include a first connector that directly connects to a second connector of the wire source outlet 74. For example, the wire feeder inlet 72 may connect to the wire source outlet 74 via quick disconnect connectors or the like through which wire from the spool 40 may be fed. In some examples, a conduit may connect the wire feeder inlet 72 to the wire source outlet 74. In some examples, the conduit is flexible (e.g., similar to a weld cable). In some examples, the conduit may be a rigid conduit. The connectors 43 enable welding wire 42 from the spool 40 to be fed to the drive components of the wire feeder 12. The connectors 43 may also enable one or more control cables to be connected from components within the wire source enclosure 17 to the control circuit 32.

Welding wire 42 is unspooled from the spool 40 and is progressively fed to the torch 16. The spool 40 may be associated with a clutch 45 that disengages the spool 40 when wire is to be fed from the spool 40 to the torch 16. The clutch 45 may also be regulated, for example by the control circuit 32, to maintain a minimum friction level to avoid free spinning of the spool 40. The first wire feeder motor 46 engages with wire feed rollers 47 that may be provided within a housing 48 to push wire 42 from the wire feeder 12 towards the torch 16.

In practice, at least one of the rollers 47 is mechanically coupled to the motor 46 and is rotated by the motor 46 to drive the wire from the wire feeder 12, while the mating roller is biased towards the wire to apply adequate pressure by the two rollers to the wire. Some systems may include multiple rollers of this type. In some examples, the wire feeder 12 is configured to feed ⅛ inch wire. In some examples, the wire feeder 12 is configured to feed 3/32 inch wire, or any other suitable size or type of wire.

A tachometer 50 or other sensor may be provided for detecting the speed of the first wire feeder motor 46, the rollers 47, or any other associated component so as to provide an indication of the actual wire feed speed. Signals from the tachometer 50 are fed back to the control circuit 32 such that the control circuit 32 can track the length of wire that has been fed. The length of wire may be used directly to calculate consumption of the wire and/or the length may be converted to wire weight based on the type of wire and its diameter.

In some examples, a second wire feeder 88 is included. The wire feeder 88 may be incorporated within the torch 16 and/or at a location along the path of the electrode wire 42. The wire feeder 88 may be controlled by the control circuitry 32 to coordinate with wire feed rollers 47 to advance and/or retract the electrode wire 42 based on a desired application.

As shown in FIG. 1, the power conversion circuitry 66 is connected to isolation circuitry 60. For example, the isolation circuitry 60 includes a switch 61 or other suitable feature (e.g., a relay, an interlock, a contactor, etc.) configured to automatically isolate one power output 62 from another power output 64. Power output 62 is a welding power output configured to provide welding power to torch 16 via conductor 68. Power output 64 is a gouging power output configured to provide gouging power to torch 76 via conductor 69. In some examples, the isolation circuitry 60 is additionally or alternatively configured to physically or electrically isolate a welding circuit element 63 from the welding power output 62. In some examples, the isolation circuitry 60 is additionally or alternatively configured to physically or electrically isolate a welding circuit element 65 from the welding power output 64. This provides an additional layer of isolation.

A selection can be communicated to the control circuitry 32, such as from an input at the interface circuitry 30 or 34 of the wire feeder 12, from interface circuitry 20, 28 or 38, and/or from an interface/trigger/switch 82 located on the welding torch 16 or an interface/trigger/switch 78, 82 located on the gouging torch 76. In some examples, selection is for a particular weld process, such as gouging or welding processes. Once received, the control circuitry 32 can control the isolation circuitry 60 to physically and/or electrically isolate one power output from the other.

In an example process, the control circuitry 32 receives a selection input to provide gouging power. The control circuitry 32 then transmits control signals to a welding power supply (e.g., via communications/power cable 14, wirelessly, and/or via a separate communications cable—not shown) to provide gouging power. The control circuitry 32 controls the isolation circuitry 60 to isolate the welding power output 62 from the gouging power output 64. This isolation can be activated by controlling switch 61 to close a circuit that includes gouging power output 64 and opening a circuit that includes welding power output 62. The control circuitry 32 controls power conversion circuitry 66 to condition and/or provide the gouging power to the gouging power output 64, and to the gouging torch 76 via cabling 69. In some examples, the control circuitry 32 further coordinates activation of the gouging torch 76 with valving 80 and/or the compressed air source 84 to ensure proper operation of the gouging torch.

Although described as the control circuitry 32 of the wire feeder 12 receiving the selection input and then transmitting control signals to the power supply 10, in some examples the selection input can be received at the power supply 10 which then controls the wire feeder 12 to activate the isolation circuitry 60.

Additionally or alternatively, the control circuitry 34 and/or control circuitry 56 adjusts one or more operational characteristics to implement the selected gouging mode or one or more welding modes.

In some examples, a pilot circuit 67 can be connected to and/or incorporated with the isolation circuitry 60. When a command is received to activate the gouging torch 76, the pilot circuit 67 is activated to generate a low voltage signal, transmitted to a tip 83 (e.g., carbon) of the gouging torch 76. When electrical contact is made between the tip 83 and workpiece 18, the pilot circuit 67 is configured to close switch 61 to enable power to flow to the power output 64.

For instance, when the isolation circuitry 60 receives a commend to transition to the gouging mode, the switch 61 may not automatically close the circuit enabling power to flow to the power output 64. Rather, the pilot circuit 67 may be activated, measuring changes in one or more electrical characteristic (e.g., resistance, impedance, etc.). When a value of the electrical characteristic changes beyond a predetermined threshold amount (e.g., corresponding to contact between the tip 83 and the workpiece 18), the pilot circuit 67 controls the switch 61 (directly or by command to the isolation circuitry 60) to close, thereby creating a path for power to flow to the gouging torch 76.

By employing a pilot circuit, the disclosed system ensures that gouging power is not flowing to the gouging torch 76 inadvertently and/or prior to a welder initiating a gouging process by contact with the workpiece 18.

Different welding processes may be more efficient with certain polarities. For example, carbon arc gouging/cutting and/or stick welding may generally be performed with a positive polarity (e.g., direct current electrode positive, or DCEP). On the other hand, TIG welding may generally be performed with a negative polarity (e.g., direct current electrode negative, or DCEN). In some examples, once selected, the command to commence a gouging operation causing a polarity change at the power source 10 (e.g., change negative polarity to a positive polarity), power control, such as amperage control, is performed at the wire feeder 12. The power for a gouging operation is provided for the torch 76 via output 64 (e.g., via power conversion circuitry 66). Moreover, it may be desirable to detect, communicate, and/or control the polarity at a remote location that is proximal to the wire feeder 12, such as the gouging torch 76, and/or at the wire feeder itself.

In some examples, gouging operations may be available at the wire feeder 12 regardless of polarity at the power supply 10. For instance, the power conversion circuitry 66 may be commanded by the control circuitry 32 to change one or more power characteristics (e.g., increase current, change specific waveforms, etc.) at the gouging power output 64.

A memory device may store processor executable instructions (e.g., firmware or software) for the control circuitry 34 or control circuitry 56 to execute. In addition, one or more control regimes for various welding processes (e.g., MIG or GTAW welding process, CAC-A plasma cutting, etc.), along with associated settings and parameters, may be stored in the memory device, along with code configured to provide a specific output (e.g., output power, power characteristics, change in polarity, initiate wire feed or set wire feeder speed, enable gas flow, wire feeder direction, travel speed, process mode, deposition path, deposition sequence, torch angle, etc.) during operation. One or more lists or look up tables may be provided, and/or network connections to various databases available to inform decision-making, such as to access preferred output parameters, to store updated parameter settings, etc.

In examples, if a gouging process has been initiated, but the torch 14 has not been activated within a given period of time, the control circuitry 32 may automatically terminate the gouging torch. This may include opening the switch 61, controlling an output at power conversion circuitry 66, closing one or more valves of compressed air, and/or activating a welding mode. In some examples, activating the torch 16 (e.g., a MIG torch, such as by a pull of trigger 22) can cause the system to exit the gouge mode.

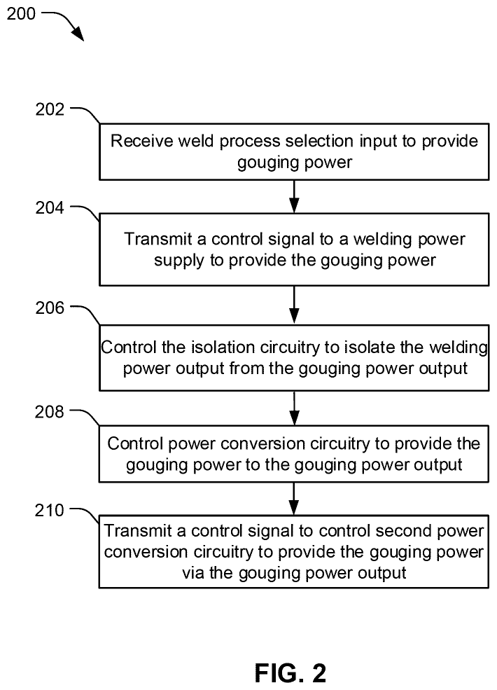

FIG. 2 shows a flowchart representative of example machine readable instructions 200 which may be executed by the control circuitry 22 and/or 32 of FIG. 1 for activating isolation circuitry, such as to power a gouging torch. In block 202, a weld process selection input to provide gouging power is received at the control circuitry.

At block 204 a control signal transmitted to a welding power supply to provide the gouging power. At block 206 the isolation circuitry is controlled to isolate the welding power output from the gouging power output. For instance, isolation circuitry is activated between a welding power output circuit and a gouging power output circuit to automatically isolate one power output from the other power output responsive to a weld process selection; and

At block 208 power conversion circuitry is controlled to provide the gouging power to the gouging power output. In additional or alternative block 210, a control signal is transmitted to control second power conversion circuitry (e.g., power conversion circuitry 24 at power supply 10) to provide the gouging power via the gouging power output.

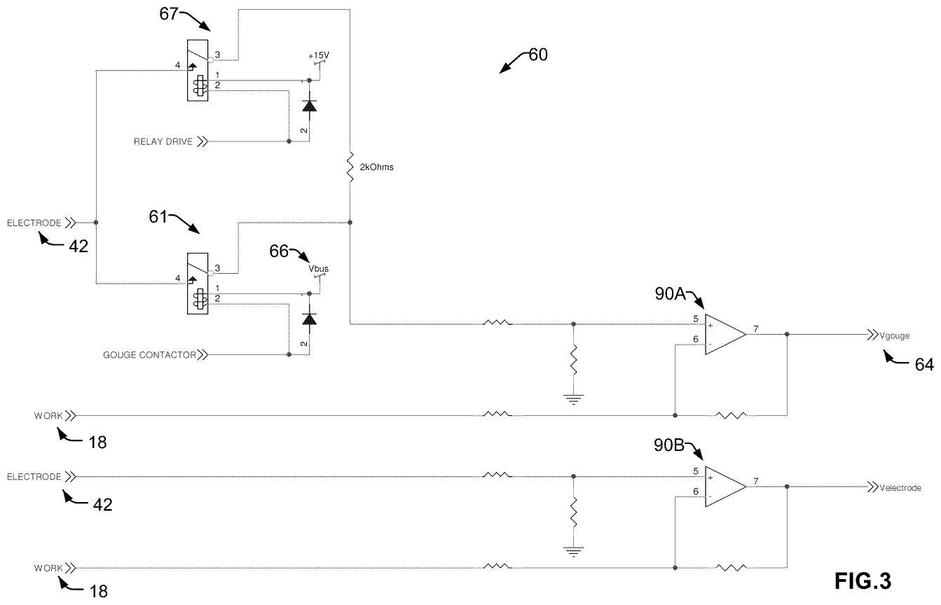

FIG. 3 illustrates a detailed view of the pilot circuit 67 in accordance with aspects of this disclosure. As shown, the pilot circuit 67 is connected to the isolation circuitry 60, receiving a low voltage signal (e.g., 15 volt signal), which can be transmitted to tip 83 via one or more circuits and/or circuit components (e.g., component 90A, 90B). When electrical contact is made between the tip 83 and workpiece 18, the pilot circuit 67 is configured to close switch 61 to enable power to flow to the power output 64.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A wire feeder, comprising:
isolation circuitry between a welding power output and a gouging power output to automatically isolate one power output from the other power output responsive to a weld process selection; and
control circuitry configured to:
receive a weld process selection input to provide gouging power;
transmit a control signal to a welding power supply to provide the gouging power;
control the isolation circuitry to isolate the welding power output from the gouging power output; and
control power conversion circuitry to provide the gouging power to the gouging power output.

2. The wire feeder of claim 1, wherein the welding power output includes welding power circuitry and the gouging power output includes gouging power circuitry.

3. The wire feeder of claim 2, wherein the welding power circuitry provides welding power to a welding torch via the welding power output and the gouging power circuitry provides the gouging power to a gouging torch via the gouging power output.

4. The wire feeder of claim 2, wherein the isolation circuitry is further configured to:
electrically or physically isolate the welding power output from the welding power circuitry; or
electrically or physically isolate the gouging power output from the gouging power circuitry.

5. The wire feeder of claim 1, wherein the power conversion circuitry is operable to receive power from the welding power supply and to provide welding power or the gouging power to the wire feeder via one or more cables.

6. The wire feeder of claim 5, wherein the control circuitry is further configured to communicate the command to control circuitry of the welding power supply via one or more of weld cable communications (WCC), wireless communications, wired communications, or any combination thereof.

7. The wire feeder of claim 1, wherein the control circuitry of the welding power supply is configured to automatically adjust output polarity of the gouging power to a polarity suitable for a gouging operation in response to a command from the wire feeder control circuitry to provide gouging power.

8. A system, comprising:
a welding power supply to supply a power output;
one or more welding torches; and
a wire feeder coupled between the welding power supply and the one or more welding torches, the wire feeder comprising:
isolation circuitry to physically or electrically isolate a welding power output from a gouging power output; and
control circuitry configured to:
receive an input to provide gouging power;
control the isolation circuitry to isolate the welding power output from the gouging power output; and
control power conversion circuitry to provide the gouging power to the gouging power output.

9. The system of claim 8, wherein the wire feeder is located remotely from the welding power supply and proximate to the one or more welding torches.

10. The system of claim 8, wherein the one or more welding torches includes a welding torch to perform a welding operation and a gouging torch to perform a gouging operation.

11. The system of claim 8, wherein the power conversion circuitry is operable to receive power from the welding power supply and to condition the power to provide welding power or the gouging power.

12. The system of claim 8, wherein the control circuitry is further configured to transmit a control signal to the welding power supply to provide power with a polarity suitable for the gouging power.

13. The system of claim 8, wherein the isolation circuitry includes a physical interlock comprising one or more of a relay, a contactor, or a switch.

14. The system of claim 8, wherein the isolation circuitry is electrically controlled by the control circuitry to close a circuit to the welding power output or the gouging power output.

15. The system of claim 8, further comprising a user interface to receive a command to provide the input to provide the welding power or the gouging power.

16. The system of claim 8, wherein the welding power supply includes welding control circuitry configured to automatically adjust output polarity of the gouging power to a polarity suitable for a gouging operation in response to a command from the wire feeder control circuitry to provide gouging power.

17. The system of claim 10, wherein the welding power supply communicates with the wire feeder via a weld power cable.

18. A welding system, comprising:
a welding power supply to supply a power output, the welding power supply comprising first power conversion circuitry; and
a wire feeder comprising:
isolation circuitry to physically or electrically isolate a welding power output from a gouging power output; and
control circuitry configured to:
receive an input to provide gouging power;
transmit a control signal to the welding power supply to control the power conversion circuitry to adjust a polarity of the power output for gouging power;
control the isolation circuitry to isolate the welding power output from the gouging power output; and
control second power conversion circuitry to provide the gouging power via the gouging power output.

19. The welding system of claim 18, wherein the control circuitry is further configured to control the second power conversion circuitry to provide the gouging power as a constant current power output.

20. The welding system of claim 18, wherein the isolation circuitry is configured to electrically or physically isolate the welding power output from the gouging power output.
